(19) United States
(12) Patent Application Publication
(10) Pub. No.: US 2021/0362933 A1
(43) Pub. Date: Nov. 25, 2021

(54) Aroma Trapping Carrying Case

(71) Applicant: Curtis Hucks, Jersey City, NJ (US)

(72) Inventor: Curtis Hucks, Jersey City, NJ (US)

(21) Appl. No.: 17/327,742

(22) Filed: May 23, 2021

Related U.S. Application Data
(60) Provisional application No. 63/029,541, filed on May 24, 2020.

(51) Int. Cl. B65D 81/26; B65D 81/30; B65D 81/02; A45C 13/10; A45C 13/30; B32B 27/40; B32B 9/00

(52) U.S. Cl. CPC B65D 81/267; B65D 81/30; B65D 81/022; A45C 13/103; A45C 13/30; B32B 2307/30; B32B 9/007; B32B 2439/40; B32B 2307/758; B32B 2307/71; B32B 27/40

(57) ABSTRACT

A hardened, aroma-trapping carrying case that is an airtight, water resistant, odor proof container assembly with first and second substantially polycarbonate container portions, the first polycarbonate container portion pivotally coupled to the second polycarbonate container portion and designed to be opened or closed, the rim portions designed to interleave contiguously to create a substantially airtight seal for true aromatherapy containment. An assembly of at least two flexible strips of metal or plastic with interlocking projections coupled to the rim portions of the container assembly is designed to coupled or uncoupled the rim portions to each other by pulling a slide assembly along the assembly of at least two flexible strips of metal or plastic with interlocking projections. At least one substantially polyurethane layer assembly and at least one substantially activated charcoal layer assembly contiguously lines the interior of the container assembly. A lock assembly is designed to prevent pulling the slide assembly when the container is closed.

### FIELD OF THE INVENTION

This invention relates generally to a travel carrying case.

### BACKGROUND

Devices that conceal or minimize malodorous organic materials are desirable in the field of pharmaceuticals. Such devices allow for consumers to travel with pharmaceutical products inconspicuously. Specifically, there is a dire need for transportable personal devices that may store and preserve pharmaceutical supplies and medications, and fragile electronics. Further, there is a need in the market for a safer means to travel with delicate medical instruments.

There is a need in the market for a safer means to travel with delicate medical instruments. Delicate items during travel are often susceptible to damage. Luggage handling is a vigorous process and thus increases the likelihood of breakage of fragile instruments. Due to this, transporting personal safety equipment, medical products, and electronics is often inconvenient and difficult for the everyday traveler. Traveling with such devices could lead to additional costly repairs. Further, there are certain restrictions put in place by the airports Transportation Security Administration (TSA). While there are several patents and patent applications in the area of pharmaceutical storage mediums, none have provided a solution to this problem.

Various patents and patent applications provide for a storage medium of pharmaceutical devices. One of these solutions attempt to utilize plastic containers, but this solution fails to meet the needs of the market because plastic containers do not trap the odor. Another solution attempts to utilize a bag, but this solution is similarly unable to meet the needs of the market because it does not protect the product or its accessories. Still another solution seeks to utilize an airtight container, but this solution also fails to meet market needs because airtight containers can be hard to transport. Still another solution seeks to utilize a carbon layer to mask the odor, but this solution does not adequately protect the product or accessories from inertial energy. What is needed is an easily transportable personal device that provides safe storage for and preservation of pharmaceutical supplies during travel, while meeting travel restrictions put in place by TSA.

### SUMMARY OF THE INVENTION

Certain embodiments commensurate in scope with the original claims subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

It is essential to the present disclosure, all embodiments are provided as illustrative and non-limiting representatives of various possible embodiments. In addition, the terms “is”, “can”, “will” and the like are herein uses as synonyms for an interchangeable with terms such as “may”, “may provide for”, and “it is contemplated that the present invention may” and so forth.

Furthermore, all elements listed by name, such as undergarment, menstrual cycle, and absorbent article, are meant to include or encompass all equivalents for such elements. Absorbent article may include disposable fluid management devices, sanitary napkins with or without connecting members, and or cotton cylindrical pads. Such equivalents are contemplated for each element named herein.

For purposes of summarizing, certain aspects, advantages, and novel features of the present invention are provided herein. It is to be understood that not all aspects, advantages, or novel features may be provided in any one particular embodiment. Thus, the disclosed subject matter may be embodied or carried out in a manner that achieves or optimizes one aspect, advantages, or novel features or group of features without achieving all aspects, advantages, or novel features as may be taught or suggested.

In view of the foregoing disadvantages inherent in the known art, the present invention provides a novel solution for transporting pharmaceutical supplies such as marijuana.

The features of the invention, which are believed to be novel, are particularly pointed out and distinctly claimed in the concluding portion of the specification. These and other features, aspects, and advantages of the present invention will become better understood with reference to the following drawings and detailed description.

In an embodiment, a hardened aroma-trapping carrying case that is an airtight, water resistant, odor proof container assembly with first and second substantially polycarbonate container portions, the first polycarbonate container portion pivotally coupled to the second polycarbonate container portion and designed to be opened or closed, the rim portions designed to interleave contiguously to create a substantially airtight and waterproof seal for true aromatherapy containment. An assembly of at least two flexible strips of metal or plastic with interlocking projections coupled to the rim portions of the container assembly is designed to coupled or uncoupled the rim portions to each other by pulling a slide assembly along the assembly of at least two flexible strips of metal or plastic with interlocking projections. At least one substantially polyurethane layer assembly and at least one substantially activated charcoal layer assembly contiguously lines the interior of the container assembly. A lock assembly is designed to prevent pulling the slide assembly when the container is closed.

The embodiment of the invention described herein are exemplary and numerous modifications, variations, and rearrangements can be readily envisioned to achieve substantially equivalent results, all of which are intended to be embraced within the spirit and scope of the invention. Furthermore, while the preferred embodiment of the invention has been described in terms of the components and configurations, it is understood that the invention is not limited to those specific dimensions or configurations but is to be accorded the full breadth of the spirit of the invention.

### BRIEF DESCRIPTION OF THE DRAWINGS

These and other features, aspects and advantages of the present invention will become better understood with regard to the following description, appended claims, and accompanying figures.

FIG. 1 illustrates a back view of the hardened aroma-trapping carrier assembly in accordance with an embodiment of the present invention.

FIG. 2 illustrates a front view of the hardened aroma-trapping carrier assembly in accordance with an embodiment of the present invention.

FIG. 3 illustrates a perspective front view of the hardened aroma-trapping carrier assembly present invention in accordance with an embodiment of the present invention.

FIG. 4 illustrates another perspective view of the hardened aroma-trapping carrier assembly present invention in accordance with an embodiment of the present invention.

FIG. 5A illustrates an open view of the hardened aroma-trapping carrier assembly present invention in accordance with an embodiment of the present invention.

FIG. 5B illustrates a perspective view of a slide assembly of the hardened aroma-trapping carrier assembly in accordance with an embodiment of the present invention.

FIG. 5C illustrates a perspective view of a mesh pocket assembly of the hardened aroma-trapping carrier assembly in accordance with an embodiment of the present invention.

FIG. 6 illustrates an open view of the hardened aroma-trapping carrier assembly in accordance with an embodiment of the present invention.

FIG. 7 illustrates a bottom view of the hardened aroma-trapping carrier assembly in accordance with an embodiment of the present invention.

FIG. 8 illustrates an interior polyurethane and charcoal layer of the hardened aroma-trapping carrier assembly in accordance with an embodiment of the present invention.

### DETAILED DESCRIPTION

The present invention overcomes the limitations of the prior art by providing a novel and non-limiting system comprising an undergarment housing and an intermediate member affixed to the undergarment housing, whereby such system may house and confine at least one absorbent article.

It is essential to understand that the drawings and the associated descriptions are provided to illustrate potential embodiments of the invention and not to limit the scope of the invention. Reference in the specification to “one embodiment” or “an embodiment” is intended to indicate that a particular feature, structure, or characteristics described in connection with the embodiment is included in at least an embodiment of the invention. The appearances of the phrases “in one embodiment” or “an embodiment” in various places in the specification are not necessarily all referring to the same embodiment.

As used in this disclosure, except where the context requires otherwise, the term “comprise” and various of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known features, elements or techniques may be shown in detail in order not to obscure the embodiments.

The system of the present invention is a hardened aroma-trapping carrier assembly. The system may be utilized for the transportation of medical equipment, devices, and supplies. Specifically, the system presents a novel carrier assembly with interlocking edges. The system includes ultraviolet diffraction and shock absorption properties to provide for the safe transportation of fragile goods. The system includes a large internal volume to enable users to store various botanicals and delicate items simultaneously. The system includes properties to maintain a low or a predetermined thermal energy to preserve the life of pharmaceutical instruments during transport. The system also includes components of secure mesh pockets, elastic bands, a slidable shoulder pad, and adjustable and detachable strap. The system employs activated charcoal and polyurethane materials to serve as an internal shock resistant formula with odor containment capabilities. The system provides consumers with a multi-functional storage compartment with odor trapping properties for overall protection of frail items at all times. The system reduces the possibility of equipment damage during travel. The exterior portions of the system comprise of a protective outer shell.

Exemplary medical equipment and devices that may be confined within the volume of the carrier assembly may include, but may not be limited to, medical instruments, vape pens, pipes, lighters, pre-rolls, blunt tubes, cannabis and or marijuana, pharmaceuticals, nutraceuticals or drugs, components of cannabis or marijuana, hemp and byproducts, botanicals, grinders, vaporizers, and the like.

The present invention provides for a hardened aroma-trapping carrier assembly. The hardened aroma-trapping carrier assembly may comprise of an airtight water-resistant assembly. More specifically, the aroma-trapping carrier assembly may comprise of a first substantially polycarbonate portion and a second substantially polycarbonate portion. The first substantially polycarbonate portion may comprise of a first exterior surface, a first interior surface, and a first rim portion. The second substantially polycarbonate portion aroma-trapping carrier assembly may also comprise of a second substantially polycarbonate portion with a second exterior surface, a second interior surface, and a second rim portion. The first polycarbonate portion may be pivotally coupled to the second polycarbonate portion. The aroma-trapping carrier assembly may be in a closed position or an open position. The first rim portion is designed to interleave contiguously with the second rim portion when the container assembly is in the closed position to create a substantially airtight seal.

An assembly of at least two flexible strips of metal or plastic with interlocking projections may be coupled to the aroma-trapping carrier assembly. A first strip assembly may be coupled to the first rim portion. A second strip assembly may be coupled to the second rim portion. The first rim portion may be coupled or uncoupled to the second rim portion by slidably pulling a slide assembly along the assembly of at least two flexible strips of metal or plastic with interlocking projections.

The aroma-trapping carrier assembly may comprise of at least one substantially polyurethane layer assembly and at least one substantially activated charcoal layer assembly. The at least one substantially polyurethane layer assembly and at least one substantially activated charcoal layer assembly contiguously line the first interior surface of the first polycarbonate carrier portion and the second interior surface of the second polycarbonate carrier portion. The activated charcoal layer assembly may be designed to absorb odors, and the polyurethane layer assembly may be designed to absorb inertial energy.

The term contiguous has a particular meaning in relation to the present invention. The term contiguous means that when the carrier assembly is in a closed position and contains a volume within its concave interior, the items within that volume are substantially encompassed by the activated charcoal layer assembly and the polyurethane layer assembly to substantially prevent the escape of odors or the presence of a substantially unpadded surface. Medical equipment and devices may be affixed to the concave interior of the carrier assembly. For example, medical instruments, vape pens, pipes, lighters, pre-rolls, blunt tubes, cannabis and or marijuana, prescription pills, hemp and byproducts, botanicals, grinders, vaporizers, and similar medical equipment and devices may be affixed therein.

The aroma-trapping carrier assembly may comprise of a lock assembly. The lock assembly may be designed to be in an open and unlocked state. The lock assembly may further be designed to be in a closed and locked state. The closed and locked state may be designed to prevent slidably pulling the slide assembly along the assembly of at least two flexible strips of metal or plastic with interlocking projections.

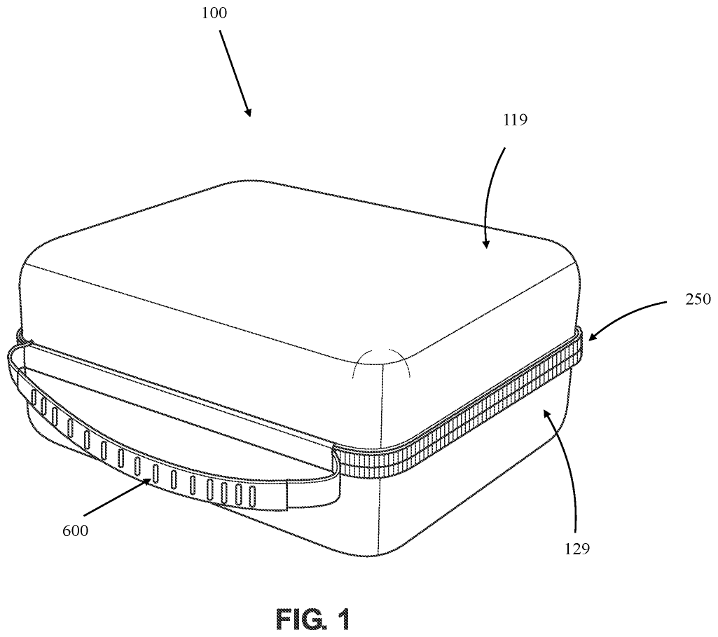

Turning attention to FIG. 1, a back view of the hardened aroma-trapping carrier assembly in accordance with an embodiment of the present invention. As shown in the figure, the invention provides for an airtight, water resistant, aroma-trapping carrier assembly 100. The aroma-trapping carrier assembly 100 may comprise of a first exterior surface 119 and a second exterior surface 129. The aroma-trapping carrier assembly 100 may further comprise of a slide assembly 250. A strap assembly 600 may be coupled to the aroma-trapping carrier assembly 100. The aroma-trapping carrier assembly 100 may be of various dimensions. For example, the dimensions of the aroma-trapping carrier assembly 100 may be at least seven mil thick, and approximately six inches long, and three inches wide (i.e. L=6 inches; W=3 inches). The first exterior surface 119 and the second exterior surface 129 may comprise of material with ultraviolet diffraction components. The strap assembly 600 may comprise of materials consisting of polyisoprene compounds. The slide assembly 250 may be a final profile to a series of interlocking projections, which together provide for an airtight aroma-trapping carrier assembly 100. The interlocking projections provide the ability to interlock adjacent articles without the need for an adhesive, and yet form a substantially gapless seam between the articles. The articles may be joined and un-joined from each other a plurality of times without any substantial deterioration of the interlocking edge profiles. Further detail will be provided in the below figures.

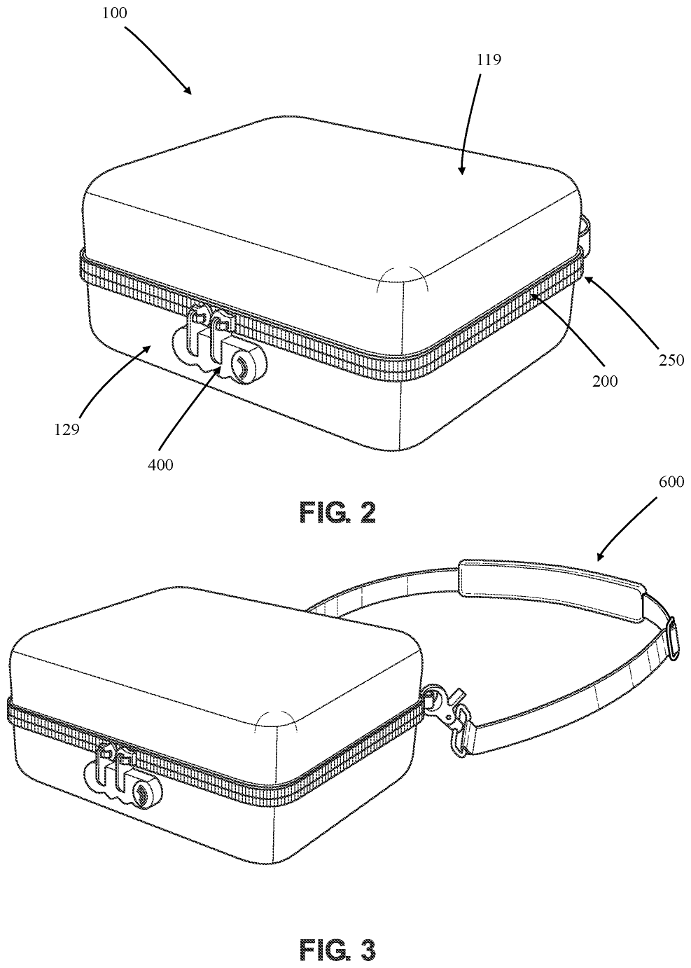

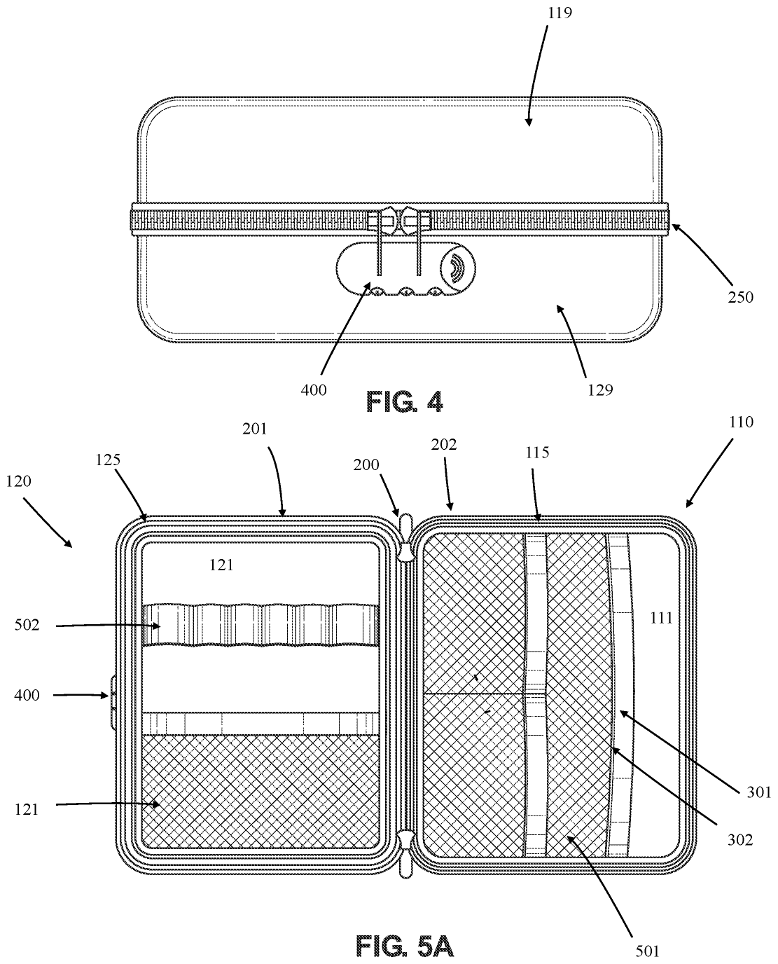

Turning attention to FIG. 2 and FIG. 4 a front view of the hardened aroma-trapping carrier assembly in accordance with an embodiment of the present invention. As shown in the figure, the aroma-trapping carrier assembly 100 may comprise of a lock assembly 400. The lock assembly 400 is designed to be in an open and unlocked state or a closed and locked state. The closed and locked state may prevent slidably pulling the slide assembly 250 along the assembly of at least two flexible strips of metal or plastic with interlocking projections 200. The front panel of the slide assembly 250 may be affixed to the lock assembly 400. The lock assembly 400 and the slide assembly 250 maintains the aroma-trapping carrier assembly 100 in an airtight and closed state. The figure further shows a front surface of the first exterior surface 119 and the second exterior surface 129.

Turning attention to FIG. 3 a perspective front view of the hardened aroma-trapping carrier assembly present invention in accordance with an embodiment of the present invention. The figure shows an alternative embodiment of the strap assembly 600 coupled to the aroma-trapping carrier assembly 100. The strap assembly 600 may consists of a detachable component, such as a removable strap clip. Further, the strap assembly 600 may be of an adjustable material. The adjustable material may allow for adjustments to the length of the strap assembly 600. The strap assembly 600 may further comprise of a slidable shoulder strap.

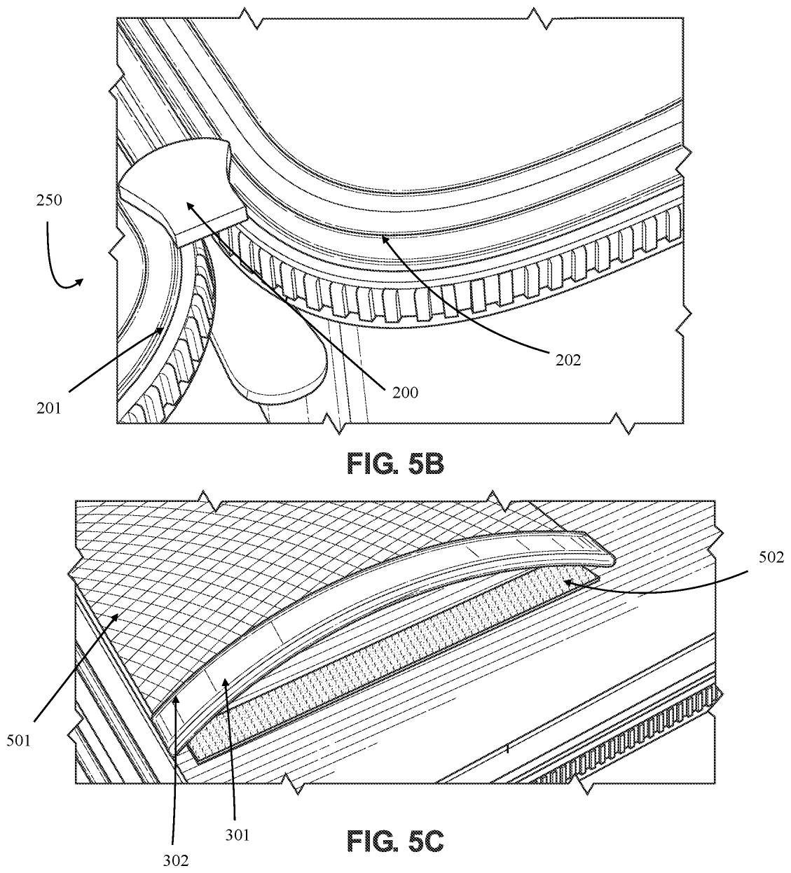

Turning attention to FIG. 5A an open view of the hardened aroma-trapping carrier assembly present invention in accordance with an embodiment of the present invention. The embodiment is of the aroma-trapping carrier assembly 100 in an open state. Displayed in the figure are at least two substantially polycarbonate carrier portions. The at least two substantially polycarbonate carrier portions may comprise of a first substantially polycarbonate carrier portion 110 and a second substantially polycarbonate carrier portion 120. The first substantially polycarbonate carrier portion 110 may be pivotally coupled to the second substantially polycarbonate carrier portion 120. The substantially polycarbonate carrier portion are designed to be in a closed position or an open position. The first substantially polycarbonate carrier portion 110 may be the interior portion to the first exterior surface 119. The second substantially polycarbonate carrier portion 120 may be the interior portion to the second exterior surface 129. The first substantially polycarbonate carrier portion 110 may comprise of a first rim portion 125. The second substantially polycarbonate carrier portion 120 may comprise of a second rim portion 115. The first rim portion 115 may comprise of an assembly of layers with interlocking abilities. The first rim portion 115 is designed to interleave contiguously with the second rim portion 125 when the aroma-trapping carrier assembly 100 is in the closed position to create a substantially airtight seal.

Further shown in FIG. 5A is an assembly of at least two flexible strips of metal or plastic with interlocking projections 200 in an open position. The assembly 200 may include a first strip assembly 201 coupled to the first rim portion 115, a second strip assembly 202 coupled to the second rim portion 125. The first rim portion 125 may couple or uncouple to the second rim portion 115 by slidably pulling a slide assembly 250 along the assembly of at least two flexible strips of metal or plastic with interlocking projections 200.

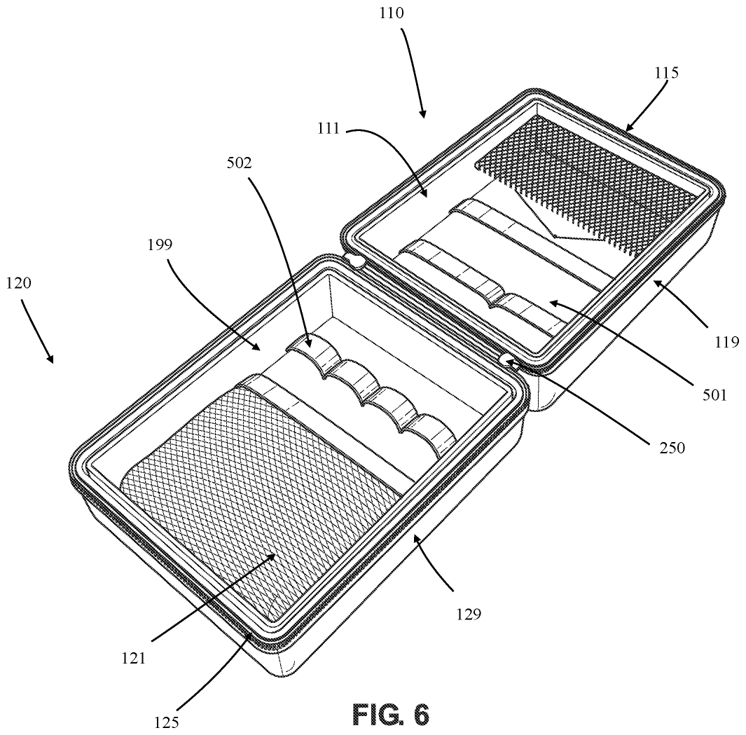

The Figure further shows the polyurethane and charcoal layer assemblies of the system. The at least one polyurethane layer assembly 301 and the at least one substantially activated charcoal layer assembly 302 contiguously lines the first interior surface 111 (see FIG. 6) of the polycarbonate carrier portion 110 and the second interior surface 121 of the second polycarbonate container portion 120. The at least one polyurethane layer assembly 301 and the at least one substantially activated charcoal layer assembly 302 may absorb malodorous organic materials. The at least one polyurethane layer assembly 301 may further comprise of properties to absorb inertial energy.

Further shown in FIG. 5A and FIG. 5C are a plurality of mesh pocket assemblies 501 and flexible band assemblies 502. The plurality of flexible band assemblies 502 may be disposed within the second polycarbonate container portion 120. The plurality of flexible band assemblies 502 may comprise of substantially polyurethane and charcoal material. The material the plurality of flexible band assemblies 502 may absorb malodorous organic materials from medical devices or equipment affixed thereto. The plurality of flexible band assemblies 502 and the mesh pocket assemblies 501 are designed to secure items disposed within the hardened aroma-trapping carrier assembly 100. Exemplary medical equipment and devices that may be confined within the volume of the mesh pocket assemblies 501 and flexible band assemblies 502 may include, but may not be limited to, medical instruments, vape pens, pipes, lighters, pre-rolls, blunt tubes, cannabis and or marijuana, pharmaceuticals, nutraceuticals or drugs, components of cannabis or marijuana, hemp and byproducts, botanicals, grinders, vaporizers, and the like.

Turning attention to FIG. 5B a perspective view of a slide assembly of the hardened aroma-trapping carrier assembly in accordance with an embodiment of the present invention. The slide assembly 250 may be a final profile to a series of interlocking projections, which together provide for an airtight hardened aroma-trapping carrier assembly 100. The slide assembly 250 may comprise of an assembly of at least two flexible strips of metal or plastic with interlocking projections 200, a first strip assembly 201 coupled to the first rim portion 115 (See FIG. 5), a second strip assembly 202 coupled to the second rim portion 125 (See FIG. 5). The interlocking projections provide the ability to interlock adjacent portions without the need for an adhesive, and yet form a substantially gapless seam between the portions. The portions may be joined and unjoined from each other a plurality of times without any substantial deterioration of the interlocking edge profiles.

Turning attention to FIG. 5C a perspective view of a mesh pocket assembly of the hardened aroma-trapping carrier assembly in accordance with an embodiment of the present invention. The plurality of mesh pocket assemblies 501 may comprise of a fastening material, such as a removable insulation blankets, fasteners made of woven tapes, and or any fastener material consisting of nylon, polyester, and nomex matter. The figure further shows the at least one polyurethane layer assembly 301 and the at least one substantially activated charcoal layer assembly 302 affixed to the plurality of mesh pocket assemblies 501 of the aroma-trapping carrier assembly 100. The at least one polyurethane layer assembly 301 and the at least one substantially activated charcoal layer assembly 302 may absorb malodorous organic materials. The at least one polyurethane layer assembly 301 may further comprise of chemical properties to absorb inertial energy. Exemplary medical equipment and devices that may be confined within the volume of the mesh pocket assemblies 501 carrier assembly may include, but may not be limited to, medical instruments, vape pens, pipes, lighters, pre-rolls, blunt tubes, cannabis and or marijuana, pharmaceuticals, nutraceuticals or drugs, components of cannabis or marijuana, hemp and byproducts, botanicals, grinders, vaporizers, and the like.

Turning attention to FIG. 6 an open view of the hardened aroma-trapping carrier assembly in accordance with an embodiment of the present invention. FIG. 6 is an alternative embodiment of the invention displayed in FIG. 5. and FIG. 6 equally comprise of the elements embodied in FIG. 5. FIG. 6 more clearly show the first interior surface 111 and the second interior surface 121. The first interior surface 111 may be the interior surface to the first exterior surface 119 and the second interior surface 121 may be the interior surface of the second exterior surface 129. The embodiments of the interior portions of the hardened aroma-trapping carrier assembly 100 comprise of substantially polyurethane and activated charcoal material to ab sorb malodorous organic materials.

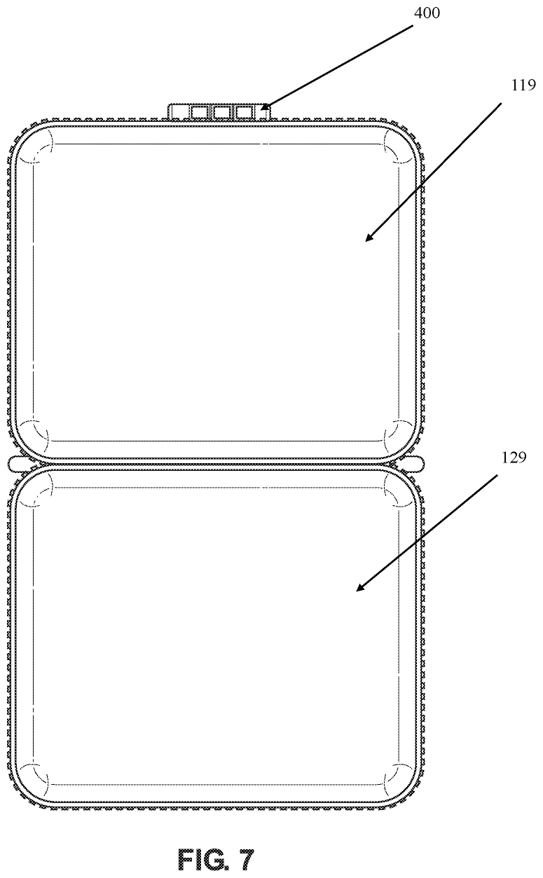

Turning attention to FIG. 7 a bottom view of the hardened aroma-trapping carrier assembly in accordance with an embodiment of the present invention. A bottom view of the first exterior portion 119 and the second exterior portion 129 are shown. The first exterior surface 119 and the second exterior surface 129 comprise of material with ultraviolet diffraction components. The ultraviolet diffraction components and the polyurethane and activated charcoal material together preserves the shelf life of pharmaceutical supplies, such as marijuana while absorbing malodorous organic materials.

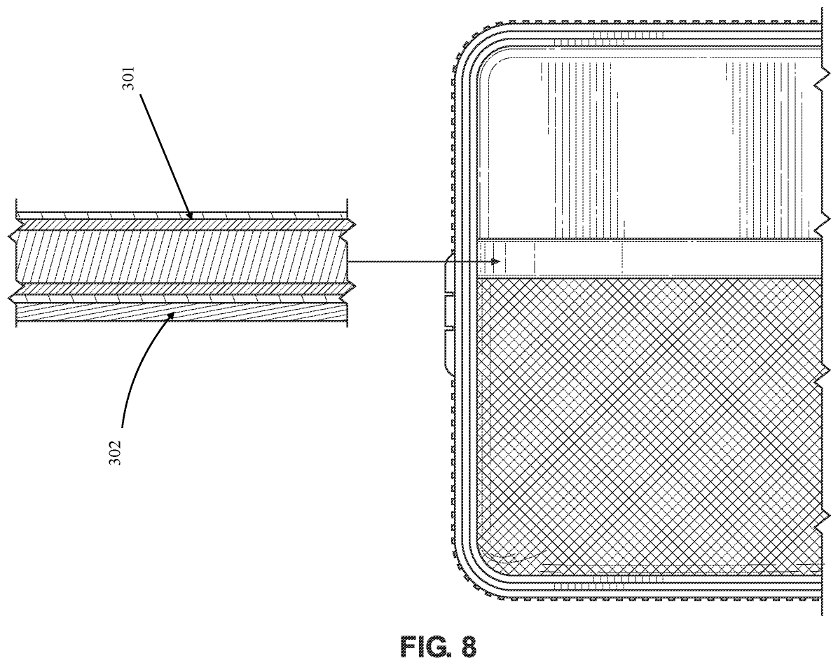

Turning attention to FIG. 8 and FIG. 9 an interior polyurethane and charcoal layer of the hardened aroma-trapping carrier assembly in accordance with an embodiment of the present invention. The figures further display the at least one polyurethane layer assembly 301 and the at least one substantially activated charcoal layer assembly 302 affixed to the plurality of mesh pocket assemblies 501 of the aroma-trapping carrier assembly 100. The at least one polyurethane layer assembly 301 and the at least one substantially activated charcoal layer assembly 302 may absorb malodorous organic materials. The at least one polyurethane layer assembly 301 may further comprise of properties to absorb inertial energy.

All features disclosed in the specification, including the claims, abstracts, and drawings, and all steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or some similar purpose, unless expressly stated otherwise. Thus, unless expressly stated otherwise, each feature disclosed is one example only of a generic series of equivalent or similar features.

While the present invention generally described herein has been disclosed in connection with a number of embodiments shown and described in detail, various modifications should be readily apparent to those of skill in the art.

What is claimed is:

1. A hardened aroma-trapping carrier assembly comprising:
an airtight, water resistant, malodorous proof container assembly having at least two polycarbonate carrier portions;
a first substantially polycarbonate carrier portion with a first exterior surface, a first interior surface, and a first rim portion;
a second substantially polycarbonate carrier portion with a second exterior surface, a second interior surface, and a second rim portion;
an assembly of at least two flexible strips of metal or plastic with interlocking projections, a first strip assembly coupled to the first rim portion, a second strip assembly coupled to the second rim portion;
at least one substantially polyurethane layer assembly and at least one substantially activated charcoal layer assembly;
a strap assembly; and
a lock assembly adapted to be in an open and unlocked state or a closed and locked state.

2. The hardened aroma-trapping carrier assembly of claim 1, wherein the at least two polycarbonate carrier portions comprise a mixture of polycarbonate and a stable dye or pigment compound intermixed with the polycarbonate adapted to block UV light from penetrating the container assembly therethrough.

3. The hardened aroma-trapping carrier assembly of claim 1, wherein the first polycarbonate carrier portion pivotally couple to the second polycarbonate carrier portion and adapted to be in a closed position or an open position;

4. The hardened aroma-trapping carrier assembly of claim 1, wherein the strap assembly comprise of polyisoprene material.

5. The hardened aroma-trapping carrier assembly of claim 1, wherein the first rim portion may couple or uncouple to the second rim portion by slidably pulling a slide assembly along the assembly of at least two flexible strips of metal or plastic with interlocking projections;

6. The hardened aroma-trapping carrier assembly of claim 1, wherein the first rim portion adapted to interleave contiguously with the second rim portion when the carrier assembly is in the closed position to create a substantially airtight seal;

7. The hardened aroma-trapping carrier assembly of claim 1, wherein the at least one substantially polyurethane layer assembly and the at least one substantially activated charcoal layer assembly contiguously line the first interior surface of the first polycarbonate carrier portion and the second interior surface of the second polycarbonate carrier portion.

8. The hardened aroma-trapping carrier assembly of claim 1, wherein the activated charcoal layer assembly may be adapted to absorb odors.

9. The hardened aroma-trapping carrier assembly of claim 1, wherein the polyurethane layer assembly adapted to absorb inertial energy.

10. The hardened aroma-trapping carrier assembly of claim 1, wherein both the first rim portions and the second rim portion comprise of an assembly of layers of interlocking edges.

11. The hardened aroma-trapping carrier assembly of claim 1, wherein the assembly of layers of interlocking edges of the first rim portion and the second rim portion may interleave contiguously.

12. The hardened aroma-trapping carrier assembly of claim 1, wherein the closed and locked state of the lock assembly may be adapted to prevent slidably pulling the slide assembly along the assembly of at least two flexible strips of metal or plastic with interlocking projections.

13. The hardened aroma-trapping carrier assembly of claim 1, wherein the at least two polycarbonate carrier portions may comprise of a plurality of mesh pocket assemblies.

14. The hardened aroma-trapping carrier assembly of claim 1, wherein the at least two polycarbonate carrier portions may comprise of a plurality of flexible band assemblies.

15. The hardened aroma-trapping carrier assembly of claim 13, wherein the plurality of mesh pocket assemblies may be disposed in the interior portion of the carrier assembly adapted to secure items disposed within the container assembly.

16. The hardened aroma-trapping carrier assembly of claim 14, wherein the plurality of flexible band assemblies may be disposed in the interior portion of the carrier assembly adapted to secure items disposed within the container assembly.

17. The aroma-trapping carrier assembly of claim 13, wherein the plurality of mesh pocket assemblies may comprise of an intermix of polyurethane and charcoal material.

18. The aroma-trapping carrier assembly of claim 14, wherein the plurality of flexible band assemblies may comprise of an intermix of polyurethane and charcoal material.

19. The hardened aroma-trapping carrier assembly of claim 1, wherein the at least two polycarbonate carrier portions maintain a predetermined thermal energy.

20. The hardened aroma-trapping carrier assembly of claim 1, wherein the at least two polycarbonate carrier portions comprise at least one of polycarbonate, polyurethane, or charcoal materials and include properties for shock absorbance, and maintaining a low thermal energy for an object disposed within the carrier portion.
